(19) United States
(12) Patent Application Publication
(10) Pub. No.: US 2024/0303069 A1
(43) Pub. Date: Sep. 12, 2024

(54) INFORMATION PROCESSING APPARATUS, INFORMATION PROCESSING METHOD, AND COMPUTER-READABLE MEDIUM

(71) Applicant: Panasonic Intellectual Property Management Co., Ltd., Osaka (JP)

(72) Inventors: Mao TOHYAMA, Kanagawa Ken (JP); Ikuo HIRADATE, Kanagawa Ken (JP); Chuntao YU, Tokyo To (JP); Kazuki ITO, Kanagawa Ken (JP); Yosuke KOBAYASHI, Kanagawa Ken (JP); Katsuhiro HAYASHI, Kanagawa Ken (JP); Hiroki OOBAYASHI, Kanagawa Ken (JP); Kento MIZUTA, Kanagawa Ken (JP); Ryosuke MURATANI, Kanagawa Ken (JP)

(73) Assignee: Panasonic Intellectual Property Management Co., Ltd., Osaka (JP)

(21) Appl. No.: 18/583,582

(22) Filed: Feb. 21, 2024

(30) Foreign Application Priority Data
Mar. 8, 2023 (JP) 2023-035200

(51) Int. Cl. G06F 8/65

(52) U.S. Cl. CPC G06F 8/65

(57) ABSTRACT

An information processing apparatus according to the present disclosure includes a memory, and a hardware processor coupled to the memory. The hardware processor is configured to: determine whether an update process of updating a program or data for providing a function of an in-vehicle device mounted on the vehicle is executable, based on position information of a vehicle, map information, and a prohibition condition indicating a condition for prohibiting execution of the update process; and cause the in-vehicle device to execute the update process when the determining that the update process is executable.

### CROSS-REFERENCE TO RELATED APPLICATIONS

This application is based upon and claims the benefit of priority from Japanese Patent Application No. 2023-035200, filed on Mar. 8, 2023, the entire contents of which are incorporated herein by reference.

### FIELD

The present disclosure relates to an information processing apparatus, an information processing method, and a computer-readable medium.

### BACKGROUND

Conventionally, when it is necessary to add a function to, correct a defect of, or upgrade a version of a program or data for providing a function of a device (in-vehicle device) such as an electronic control unit (ECU) mounted on a vehicle, it is known that an update process of rewriting to a new program or data is performed.

In execution of the update process, a user is first inquired of whether or not to permit execution of the update process, and the update process is performed when the user gives a permission. Since the vehicle cannot travel during the update process, there is known a technique in which position information indicating a position where the execution of the update process is permitted or prohibited is registered in advance, in order to prevent the update process from being executed in an inappropriate location, and whether the update process can be executed is determined using the position information registered in advance (pre-registered position information).

A related technique is described in JP 6696417 B2

However, in the above technique, since whether an update process can be executed can be determined only from the pre-registered position information, there is no flexibility, and there is a case where excitability of the update process cannot be appropriately determined.

The present disclosure is made in view of the above, and has an object to provide an information processing apparatus, an information processing method, and a computer-readable medium that can appropriately determine whether an update process can be executed.

### SUMMARY

An information processing apparatus according to the present disclosure includes a memory, and a hardware processor coupled to the memory. The hardware processor is configured to: determine whether an update process of updating a program or data for providing a function of an in-vehicle device mounted on the vehicle is executable, based on position information of a vehicle, map information, and a prohibition condition indicating a condition for prohibiting execution of the update process; and cause the in-vehicle device to execute the update process when the determining that the update process is executable.

### BRIEF DESCRIPTION OF THE DRAWINGS

FIG. 1 is a diagram illustrating an example of a system configuration of a vehicle according to an embodiment ;

FIG. 2 is a diagram illustrating an example of a hardware configuration of an ECU according to the embodiment;

FIG. 3 is a diagram illustrating an example of a hardware configuration of a gateway according to the embodiment;

FIG. 4 is a diagram illustrating an example of functions of a processing unit of the gateway according to the embodiment;

FIG. 5 is a diagram illustrating an example of detailed functions of an update determination information acquisition unit according to the embodiment;

FIG. 6 is a diagram illustrating an example of determination regarding whether an update process can be executed according to the embodiment;

FIG. 7 is a diagram illustrating an example of determination regarding whether the update process can be executed according to the embodiment ;

FIG. 8 is a diagram illustrating an example of determination regarding whether the update process can be executed according to the embodiment ;

FIG. 9 is a diagram illustrating an example of determination regarding whether the update process can be executed according to the embodiment ;

FIG. 10 is a diagram illustrating an example of determination regarding whether the update process can be executed according to the embodiment ;

FIG. 11 is a diagram illustrating an example of a message indicating a reason for not executing the update process according to the embodiment ;

FIG. 12 is a diagram illustrating an example of a screen indicating a location where the update process cannot be executed according to the embodiment ;

FIG. 13 is a diagram illustrating an example of a reason for not executing the update process and a message prompting movement to a location where the update process can be executed according to the embodiment ;

FIG. 14 is a diagram illustrating an example of a message indicating poor accuracy of position information according to the embodiment;

FIG. 15 is a diagram illustrating an example of a message according to the embodiment;

FIG. 16 is a flowchart illustrating an example of a process executed by the gateway according to the embodiment;

FIG. 17 is a diagram illustrating an example of update permission information according to a second embodiment;

FIG. 18 is a diagram illustrating a display example of an icon indicating that execution of an update process is prohibited according to the second embodiment ;

FIG. 19 is a diagram illustrating an example of a message output by audio according to the second embodiment ; and

FIG. 20 is a flowchart illustrating an example of a process executed by a gateway according to the second embodiment.

### DETAILED DESCRIPTION

Hereinafter, an information processing apparatus, an information processing method, and a program according to embodiments of the present disclosure will be described in detail with reference to the accompanying drawings.

### First Embodiment

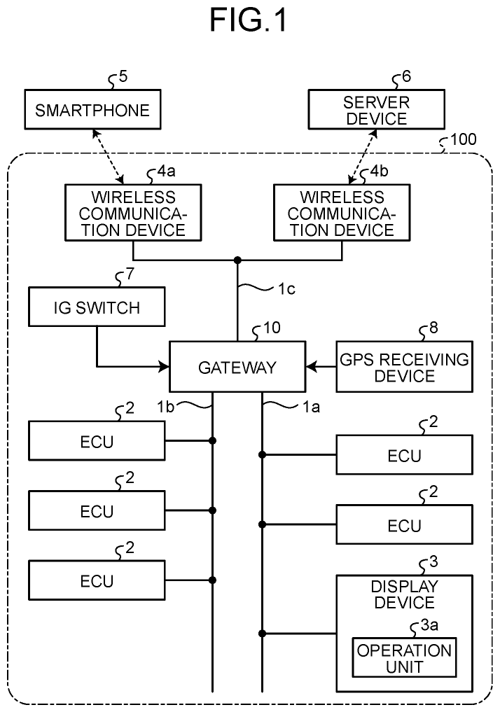

FIG. 1 is a diagram illustrating an example of a system configuration of a vehicle 100 in which a gateway 10 is installed. The gateway 10 is an example of an “information processing apparatus”. As illustrated in FIG. 1, a plurality of electronic control units (ECUs) 2 mounted on the vehicle 100 is configured to be able to communicate with each other via communication lines 1a and 1b and the gateway 10 provided in the vehicle 100. In the example in FIG. 1, the communication line 1a and the communication line 1b are connected to the gateway 10. Two ECUs 2 and a display device 3 are connected to the communication line 1a, and the three ECUs 2 are connected to the communication line 1b.

As illustrated in FIG. 1, a communication line 1c is further connected to the gateway 10. A wireless communication device 4a and a wireless communication device 4b are connected to the communication line 1c. In the example in FIG. 1, the gateway 10 can communicate with a smartphone 5, which is an example of a terminal possessed by a user, via the wireless communication device 4a. In addition, the gateway 10 can communicate with a server device 6 provided outside the vehicle 100 via the wireless communication device 4b.

Further, as illustrated in FIG. 1, an ignition switch (IG switch) 7 provided in the vehicle 100 inputs an IG signal to the gateway 10. Further, a GPS signal (radio wave transmitted from a GPS satellite) is input to the gateway 10 from a GPS receiving device 8 provided in the vehicle 100.

The gateway 10 relays data by transmitting data received from any one of the communication lines 1a to 1c configuring an in-vehicle network of the vehicle 100 to another communication line (any one of 1a to 1c). A detailed configuration of the gateway 10 will be described later.

The ECU 2 is an example of an “in-vehicle device” indicating a device mounted on the vehicle 100. A plurality of ECUs 2 includes, for example, an ECU 2 that controls an operation of an engine of the vehicle 100, an ECU 2 that controls locking/unlocking of a door, an ECU 2 that controls turning on/off of a light, an ECU 2 that controls an operation of an airbag, an ECU 2 that controls an operation of an antilock brake system (ABS), and the like. Each of the ECUs 2 is connected to the communication line 1a or 1b provided in the vehicle 100, and can transmit and receive information to and from another ECU 2 and the gateway 10 via the communication line 1a or 1b.

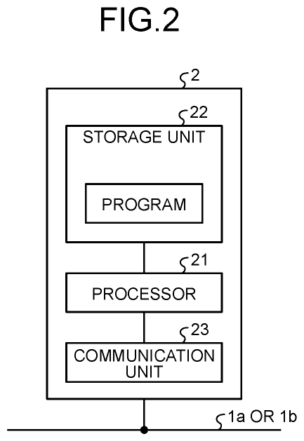

FIG. 2 is a diagram illustrating an example of a hardware configuration of the ECU 2 according to the present embodiment. The hardware configuration of each ECU 2 is basically the same. As illustrated in FIG. 2, the ECU 2 includes a processor 21, a storage unit 22, and a communication unit 23.

The processor 21 can implement various functions by integrally controlling the operation of the ECU 2 and executing a program stored in the storage unit 22. The program stored in the storage unit 22 is different for each function of the ECU 2 (different for each ECU 2).

The storage unit 22 stores a program executed by the processor 21, data necessary for executing the program, and the like. The storage unit 22 includes, for example, a nonvolatile memory that stores a program or the like such as a flash memory or an EEPROM, and a volatile memory such as a RAM that functions as a work area when the processor 21 executes the program.

The communication unit 23 is connected to the communication line 1a or 1b, and can transmit and receive information according to a communication protocol such as a controller area network (CAN). The communication unit 23 can output the information received from the processor 21 to the communication line 1a or 1b and transmit the information to outside, or can transmit the information received from the communication line 1a or 1b (e.g., acquiring the information by sampling a potential of the communication line 1a or 1b) to the processor 21.

In the present embodiment, the processor 21 has a function of performing an update process of updating the program or data (program or data for providing the function of the ECU 2) stored in the storage unit 22. For example, the processor 21 can receive update information (program or data) from the gateway 10 via the communication unit 23 and perform the update process using the update information received.

Returning to FIG. 1, the description will be continued. The display device 3 is, for example, a liquid crystal display, and can display a message or the like to the user of the vehicle 100 according to a display command or the like given from the ECU 2 or the gateway 10. In addition, the display device 3 includes an operation unit 3a such as a touch panel or a hardware key, accepts user's operation on the operation unit 3a, and notifies the ECU 2 or the gateway 10 of the operation accepted. Note that the display device 3 may be shared with, for example, a car navigation device.

The wireless communication device 4a is a device capable of wirelessly communicating with the smartphone 5. In addition, the wireless communication device 4a is connected to the communication line 1c, and can transmit and receive data to and from the gateway 10 via the communication line 1c.

The wireless communication device 4b can transmit and receive information to and from the server device 6 provided outside the vehicle 100 via a network such as a mobile phone communication network or a local area network (LAN). The wireless communication device 4b can relay communication between the gateway 10 and the server device 6, can also transmit information received from the gateway 10 to the server device 6, and can also transmit information received from the server device 6 to the gateway 10.

In the present embodiment, the wireless communication device 4a that wirelessly communicates with the smartphone 5 and the wireless communication device 4b that wirelessly communicates with the server device 6 are individually provided, but the present disclosure is not limited thereto. For example, one wireless communication device 4 capable of wirelessly communicating with both of the smartphone 5 and the server device 6 may be provided in the vehicle 100.

The smartphone 5 is, for example, a portable communication terminal carried by the user of the vehicle 100. In the smartphone 5, an application (program) for transmitting and receiving information to and from the gateway 10 via the wireless communication device 4a is installed. Note that the smartphone 5 may not communicate with the gateway 10 via the wireless communication device 4a, but may communicate with the gateway 10 via a communication cable such as a universal serial bus (USB). Furthermore, a terminal carried by the user and used for communicating with the gateway 10 is not limited to the smartphone 5, and may be, for example, a mobile phone, a tablet terminal, a notebook computer, or a game machine.

The server device 6 manages and stores programs and data executed by the ECU 2 mounted on the vehicle 100. The server device 6 notifies whether it is necessary to update the program or the like in response to an inquiry from the vehicle 100, and transmits update information (program or data) to the vehicle 100 in response to a request from the vehicle 100.

The IG switch 7 is a switch for the user to start an engine of the vehicle 100 or the like, and is switched to one of two states of ON and OFF. The IG signal is a signal indicating a state of the IG switch 7, and the IG signal indicating the ON state is a state in which, for example, the engine of the vehicle 100 is operating and power generation is being performed by an alternator or the like. The IG signal indicating the OFF state is a state in which the engine of the vehicle 100 is stopped and power generation is not being performed. In the present embodiment, the IG signal indicating the ON state is a state in which the vehicle 100 is traveling regardless of a vehicle speed, and the IG signal indicating the OFF state is a state in which the vehicle 100 is stopped (parked). However, distinction between the traveling state and the parking state of the vehicle 100 is not limited to a mode based on the IG signal, and may be, for example, a mode determined based on a position of a shift lever of the vehicle 100, a state of a parking brake, a speed of the vehicle 100, or the like, or a mode determined by combining the IG signal and these states.

The GPS receiving device 8 receives the GPS signal indicating a radio wave transmitted from each of a plurality of GPS satellites, and transmits the GPS signal received to the gateway 10. For example, a current position of the vehicle 100 can be determined by three-dimensional positioning based on a plurality of GPS signals received by the GPS receiving device 8.

In the present embodiment, when the IG switch 7 is in the ON state, communication is performed between the gateway 10 and the server device 6, and update information is transmitted from the server device 6 to the gateway 10. The gateway 10 determines whether the above-described update process can be executed, and when a determination result is affirmative and the IG switch 7 is in the OFF state (when the vehicle 100 stops), the gateway causes the ECU 2 to execute the update process using the update information acquired from the server device 6. Hereinafter, a specific configuration of the gateway 10 will be described.

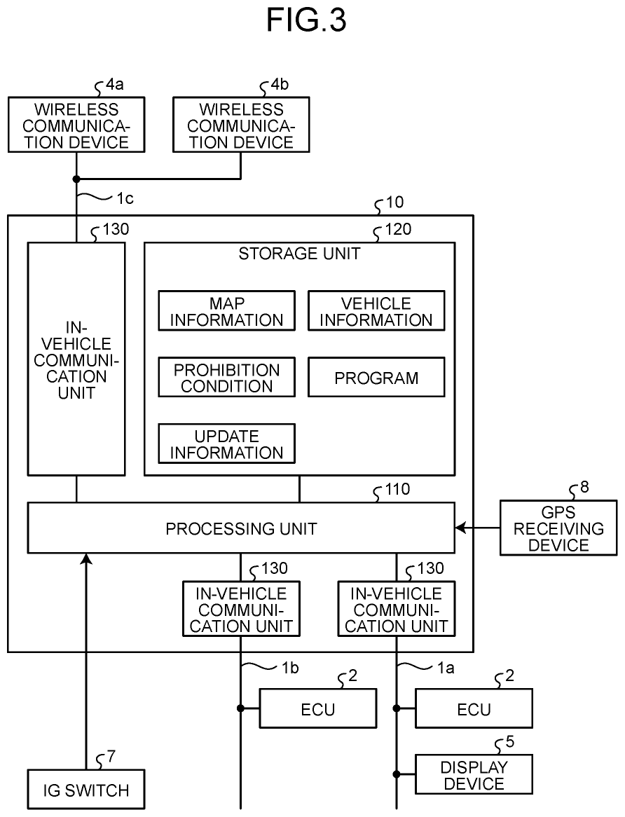

FIG. 3 is a diagram illustrating an example of a hardware configuration of the gateway 10. As illustrated in FIG. 3, the gateway 10 includes a processing unit 110, a storage unit 120, and an in-vehicle communication unit 130. Note that hardware elements of the gateway 10 are not limited to the configuration illustrated in FIG. 3, and may be in a form including other hardware elements.

The processing unit 110 is a device that integrally controls the operation of the gateway 10, and includes, for example, an arithmetic processing device such as a CPU or an MPU. The processing unit 110 can implement various functions by executing a program stored in the storage unit 120. Various functions of the processing unit 110 will be described later.

The storage unit 120 stores map information, vehicle information, a prohibition condition, a program executed by the processing unit 110 (including data for executing the programs), the update information acquired from the server device 6, and the like.

The vehicle information is information including at least the size or type of the vehicle 100. For example, the vehicle information includes information indicating a size such as a width and a total length of the vehicle 100, and information indicating a vehicle type that can identify whether the vehicle is a passenger car or a truck.

The prohibition condition is a condition for prohibiting (not permitting) execution of the update process. For example, it is possible to set, as the prohibition condition, a geographical condition such as a parking prohibited area near a traffic signal, a place with a narrow road width (place where two or more vehicles including own vehicle 100 cannot pass), a no entry area such as a private land, or a parking and stopping prohibited area. The place with a narrow road width can be determined by whether two or more vehicles including the own vehicle 100 can pass based on the size indicated by the above-described vehicle information in addition to the map information. Further, the no entry area or the parking and stopping prohibited area can be determined based on the vehicle type indicated by the above-described vehicle information in addition to the map information. This is because the no entry area or the parking and stopping prohibited area may be different for each vehicle type. A specific process using the vehicle information and the prohibition condition will be described later.

The in-vehicle communication unit 130 is connected to the communication lines 1a to 1c configuring the in-vehicle network, and transmits and receives information according to the communication protocol such as CAN. In the example in FIG. 3, the gateway 10 includes three in-vehicle communication units 130, but the number of in-vehicle communication units 130 can be arbitrarily changed according to design conditions and the like. Furthermore, each of the in-vehicle communication units 130 may perform communication according to the same communication protocol, or may perform communication according to different communication protocols.

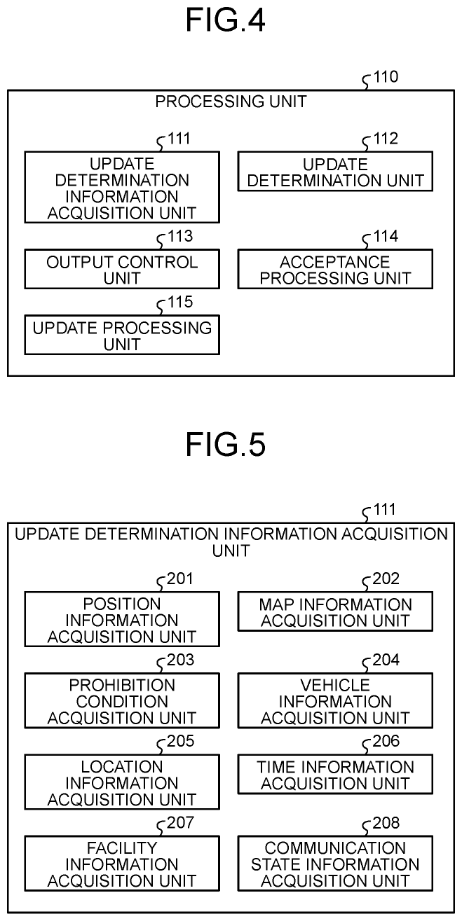

FIG. 4 is a diagram illustrating an example of functions of the processing unit 110 of the gateway 10. As illustrated in FIG. 4, the processing unit 110 includes an update determination information acquisition unit 111, an update determination unit 112, an output control unit 113, an acceptance processing unit 114, and an update processing unit 115. Note that, in the example in FIG. 4, only the functions necessary for describing a main part of the present embodiment are illustrated, and the functions of the processing unit 110 are not limited thereto.

The update determination information acquisition unit 111 acquires update determination information indicating information used for determining whether the update process can be executed. FIG. 5 is a diagram illustrating an example of detailed functions of the update determination information acquisition unit 111. As illustrated in FIG. 5, the update determination information acquisition unit 111 includes a position information acquisition unit 201, a map information acquisition unit 202, a prohibition condition acquisition unit 203, a vehicle information acquisition unit 204, a location information acquisition unit 205, a time information acquisition unit 206, a facility information acquisition unit 207, and a communication state information acquisition unit 208.

A position information acquisition unit 201 acquires position information indicating a position of the vehicle 100. In the present embodiment, the position information acquisition unit 201 can obtain the position information of the vehicle 100 based on the GPS signal input from the GPS receiving device 8, and acquire the position information obtained. A function of obtaining the position information of the vehicle 100 based on the GPS signal may be provided separately from the position information acquisition unit 201. For example, the position information acquisition unit 201 may acquire the position information obtained by another function without obtaining the position information of the vehicle 100 based on the GPS signal input from the GPS receiving device 8.

The map information acquisition unit 202 acquires the map information. In the present embodiment, the map information acquisition unit 202 acquires the map information stored in the storage unit 120. In the present embodiment, a storage destination of the map information is the storage unit 120 in the gateway 10, but the present disclosure is not limited thereto. The storage destination of the map information can be arbitrarily changed, and may be stored in, for example, a memory provided outside the gateway 10 in the vehicle 100. Further, for example, the map information acquisition unit 202 may access a device outside the vehicle 100 (external device such as a server) and acquire the map information from the external device.

The prohibition condition acquisition unit 203 acquires the above-described prohibition condition. In the present embodiment, the prohibition condition acquisition unit 203 acquires the prohibition condition stored in the storage unit 120. In the present embodiment, a storage destination of the prohibition condition is the storage unit 120 in the gateway 10, but the storage destination is not limited thereto. The storage destination of the prohibition condition can be arbitrarily changed, and may be stored in, for example, a memory provided outside the gateway 10 in the vehicle 100. Furthermore, for example, the prohibition condition acquisition unit 203 may access a device outside the vehicle 100 (external device such as a server) and acquire the prohibition condition from the external device.

The vehicle information acquisition unit 204 acquires the above-described vehicle information. In the present embodiment, the vehicle information acquisition unit 204 acquires the vehicle information stored in the storage unit 120. In the present embodiment, a storage destination of the vehicle information is the storage unit 120 in the gateway 10, but the present disclosure is not limited thereto. The storage destination of the vehicle information can be arbitrarily changed, and may be stored in, for example, a memory provided outside the gateway 10 in the vehicle 100. Furthermore, for example, the vehicle information acquisition unit 204 may access a device outside the vehicle 100 (external device such as a server) and acquire the vehicle information from the external device.

The location information acquisition unit 205 acquires location information indicating information regarding a location corresponding to the position information of the vehicle. The location information includes, for example, information indicating a degree of congestion of other vehicles. For example, the location information acquisition unit 205 can specify a location corresponding to the position information acquired by the position information acquisition unit 201 with reference to the map information acquired by the map information acquisition unit 202, and request and acquire location information regarding the specified location from a device (external device) outside the vehicle 100 such as a server.

The time information acquisition unit 206 acquires time information indicating the current time. Various known techniques can be used as a method of acquiring the time information.

The facility information acquisition unit 207 acquires facility information indicating information on a facility in the map information acquired by the map information acquisition unit 202. For example, the facility information includes business hours and the like of the facility. For example, the facility information acquisition unit 207 can request and acquire the facility information from a device (external device) outside the vehicle 100 such as a server.

The communication state information acquisition unit 208 acquires communication state information indicating a communication state between the own apparatus (gateway 10) and the outside. In the present embodiment, the communication state information acquisition unit 208 can acquire, from the in-vehicle communication unit 130, communication state information indicating a communication state (whether mutually connected, whether a sufficient communication speed is secured, and the like) between the wireless communication device 4b and the server device 6 that stores and manages the update information.

In the present embodiment, the position information, the prohibition condition, the map information, the vehicle information, the location information, the time information, the facility information, the communication state information, and the like described above are included in the update determination information.

Returning to FIG. 4, the description will be continued. The update determination unit 112 determines whether the update process can be executed. In the present embodiment, the update determination unit 112 determines whether the update process can be executed based on the position information acquired by the position information acquisition unit 201, the map information acquired by the map information acquisition unit 202, and the prohibition condition acquired by the prohibition condition acquisition unit 203. For example, it is assumed that a geographical condition of the vicinity of the traffic signal is set as the prohibition condition. In this case, the update determination unit 112 refers to the map information to determine whether the position of the vehicle 100 indicated by the position information corresponds to the vicinity of the traffic signal. When the position of the vehicle 100 corresponds to the vicinity of the traffic signal, the update determination unit 112 can determine not to permit execution of the update process.

For example, it is assumed that a geographical condition of a private land is set as the prohibition condition. In this case, the update determination unit 112 can determine whether the position of the vehicle 100 indicated by the position information in the map information is included in the private land, and can determine not to permit execution of the update process when the position of the vehicle 100 is included in the private land.

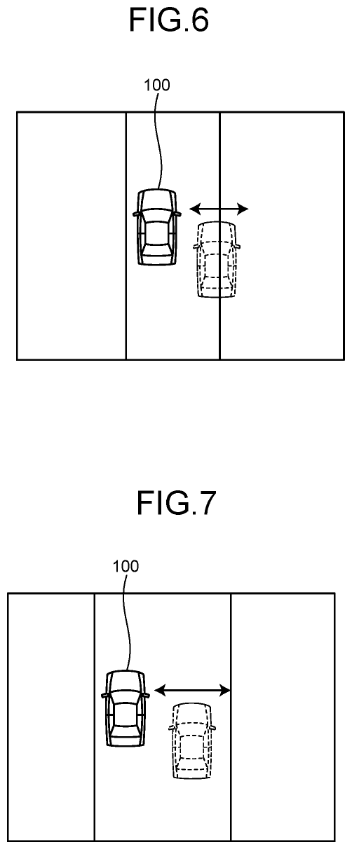

Further, the update determination unit 112 can determine whether the update process can be executed based on the vehicle information acquired by the above-described vehicle information acquisition unit 204. For example, it is assumed that a geographical condition of a place with a narrow road width (place where two or more vehicles including the own vehicle 100 cannot pass) is set as the prohibition condition. In this case, the update determination unit 112 determines whether the width of the road corresponding to the position of the vehicle 100 indicated by the position information in the map information indicates that two or more vehicles including the own vehicle 100 can pass through by using the width of the road and the size such as the width of the vehicle 100 indicated by the vehicle information. For example, as illustrated in FIG. 6, when determining that two or more vehicles including the own vehicle 100 cannot pass through the width of the road corresponding to the position of the own vehicle 100, the update determination unit 112 can determine not to permit execution of the update process. In other words, the update determination unit 112 can determine that the position of the vehicle 100 is not a place to permit execution of the update process (determine that the position is a place to prohibit execution of the update process).

On the other hand, for example, as illustrated in FIG. 7, when determining that two or more vehicles including the own vehicle 100 can pass through the width of the road corresponding to the position of the own vehicle 100, the update determination unit 112 can determine to permit execution of the update process. In other words, the update determination unit 112 can determine that the position of the vehicle 100 is a place where execution of the update process is permitted (determine that the position is not a place where execution of the update process is prohibited).

Returning to FIG. 4, the description of the update determination unit 112 will be continued. For example, it is assumed that a geographical condition of a parking/stopping prohibited area is set as the prohibition condition. In this case, the update determination unit 112 can determine whether an area corresponding to the position of the vehicle 100 indicated by the position information in the map information is a parking/stopping prohibited area by using the information of the area and the type of the vehicle 100 indicated by the vehicle information. For example, when the vehicle type of the vehicle 100 is a truck and the area corresponding to the position information in the map information is an area where parking and stopping of the truck is prohibited, the update determination unit 112 can determine not to permit execution of the update process. For example, depending on a convenience store or a supermarket, an area prohibiting parking and stopping of a large vehicle such as a truck may be provided. In the present embodiment, execution of the update process in such a place is prohibited.

Further, the update determination unit 112 can determine whether the update process can be executed based on the location information acquired by the above-described location information acquisition unit 205. For example, it is assumed that the location information includes information indicating the degree of congestion of other vehicles. In this case, when the degree of congestion indicated by the location information corresponding to the position of the vehicle 100 indicated by the position information in the map information is equal to or greater than a threshold, the update determination unit 112 can determine not to permit execution of the update process. When the update process is executed in this situation, the vehicle 100 stopped until the update process is completed may worsen the congestion. In this example, since the update determination unit 112 determines not to permit execution of the update process at a point where the degree of congestion is equal to or greater than the threshold, worsening of congestion can be suppressed.

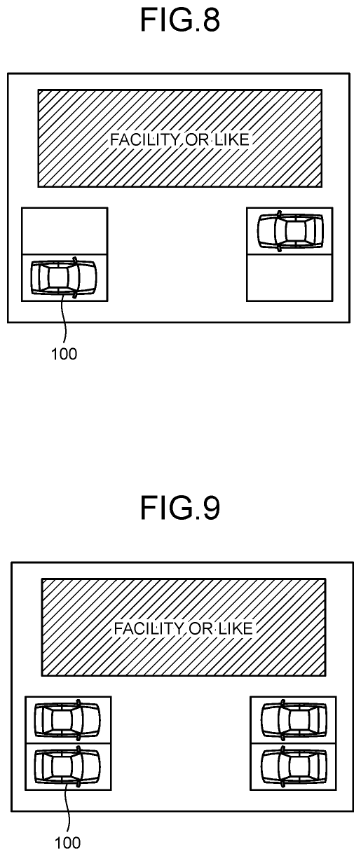

FIGS. 8 and 9 are examples in which a parking lot adjacent to a facility or the like is assumed as a place corresponding to the position of the vehicle 100. The example in FIG. 8 illustrates a state in which the degree of congestion is less than the threshold (non-congested state), and the example in FIG. 9 illustrates a state in which the degree of congestion is equal to or greater than the threshold (congested state). In the case of FIG. 8, the update determination unit 112 determines to permit execution of the update process. In other words, the update determination unit 112 determines that the position of the vehicle 100 is a location where execution of the update process is permitted. On the other hand, in the case of FIG. 9, the update determination unit 112 determines not to permit execution of the update process. In other words, the update determination unit 112 determines that the position of the vehicle 100 is a location not to permit execution of the update process.

Returning to FIG. 4, the description of the update determination unit 112 will be continued. The update determination unit 112 can further determine whether the update process can be executed based on the time information acquired by the above-described time information acquisition unit 206. More specifically, when the current time indicated by the time information acquired by the time information acquisition unit 206 is outside business hours of the facility adjacent to the location corresponding to the position information acquired by the position information acquisition unit 210, the update determination unit 112 can determine not to permit execution of the update process. In other words, the update determination unit 112 can determine that it is time at which execution of the update process is not permitted (prohibited). On the other hand, when the current time indicated by the time information acquired by the time information acquisition unit 206 is within the business hours of the facility adjacent to the location corresponding to the position information acquired by the position information acquisition unit 210, the update determination unit 112 can determine to permit execution of the update process. In other words, the update determination unit 112 can determine that it is time (timing) at which execution of the update process is permitted.

More specifically, when there is a facility adjacent to the location corresponding to the position information acquired by the position information acquisition unit 201 with reference to the map information acquired by the map information acquisition unit 202, the update determination unit 112 acquires the facility information related to the facility from the facility information acquisition unit 207. As described above, since the facility information includes the business hours of the facility, the update determination unit 112 can determine whether the current time indicated by the time information acquired by the time information acquisition unit 206 is outside the business hours indicated by the facility information, and determine whether the update process can be executed.

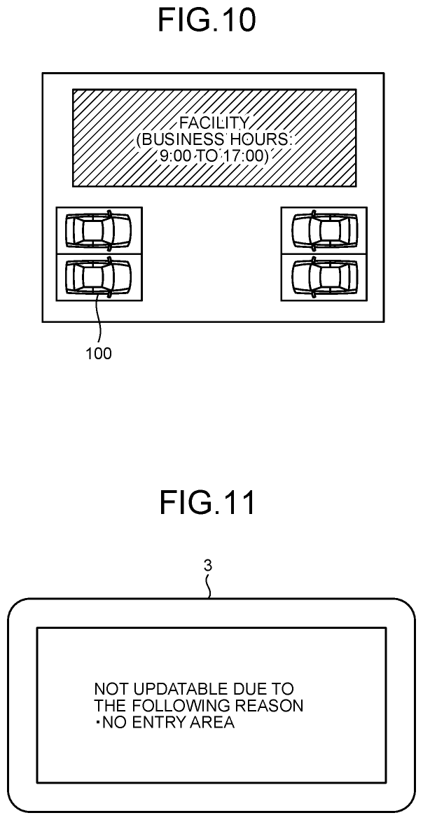

For example, as illustrated in FIG. 10, it is assumed that a location corresponding to the own vehicle 100 is a parking lot, and business hours of a facility adjacent to the parking lot are 9:00 to 17:00. For example, when the current time is 16:00, it is within the business hours, so that the update determination unit 112 can determine to permit execution of the update process. On the other hand, for example, when the current time is 19:00, it is outside business hours, so that the update determination unit 112 can determine not to permit execution of the update process.

Returning to FIG. 4, the description of the update determination unit 112 will be continued. The update determination unit 112 can further determine whether the update process can be executed based on the communication state information acquired by the above-described communication state information acquisition unit 208. For example, when the communication state indicated by the communication state information is poor (e.g., the gateway 10 and the server device 6 are not connected to a network or a sufficient communication speed cannot be secured), the update determination unit 112 can determine not to permit execution of the update process.

In the present embodiment, when a determination result of each determination described above is affirmative and the vehicle 100 is stopped (parked or stopped), the update determination unit 112 finally permits execution of the update process of the vehicle 100. As described above, whether the vehicle 100 is stopped can be determined based on the IG signal. Further, in the present embodiment, the update determination unit 112 determines whether the update process can be executed, using the update determination information including the position information, the prohibition condition, the map information, the vehicle information, the location information, the time information, the facility information, and the communication state information. However, the present disclosure is not limited thereto, and for example, the update determination unit 112 may determine whether the update process can be executed, without using a part or all of information other than the position information, the prohibition condition, and the map information in the update determination information.

The description of FIG. 4 will be continued. The output control unit 113 illustrated in FIG. 4 controls output of information. For example, the output control unit 113 can perform control display information on the display device 3 and can perform control to output information by audio from a speaker (not illustrated). For example, when the update determination unit 112 determines that the update process can be executed, the output control unit 113 performs a process of inquiring the user whether the update process can be executed. For example, the output control unit 113 performs control to display, on the display device 3, a message inquiring of the user whether the update process can be executed. For example, the output control unit 113 can perform control to display, on the display device 3, an inquiry message such as “Is the update process of the ECU software to be executed?”. The user can respond to this inquiry by operating the operation unit 3a of the display device 3.

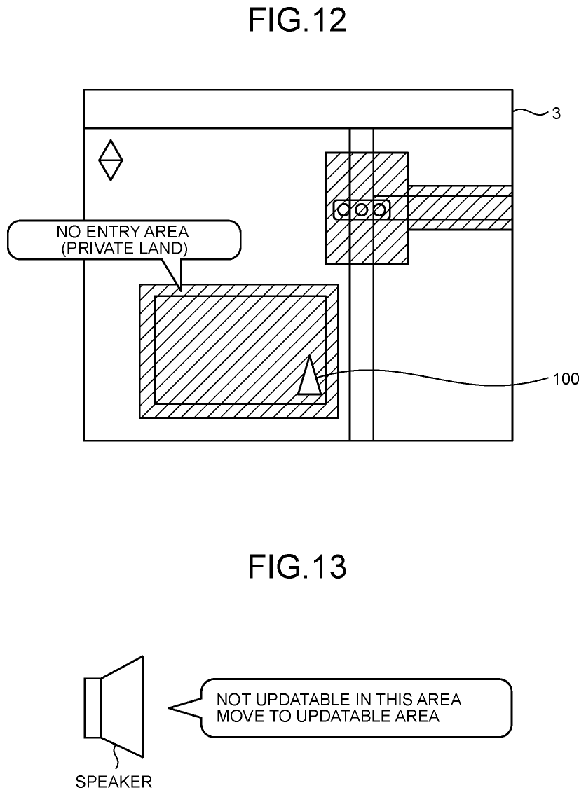

Furthermore, when the vehicle 100 stops at a location determined by the update determination unit 112 to be incapable of executing the update process (determined not to permit execution of the update process), the output control unit 113 can also perform control to output information that the vehicle 100 stops at the location. In this case, for example, the output control unit 113 can also perform control to output a reason why the update process cannot be executed. For example, the output control unit 113 can also perform control to display, on the display device 3, a message as illustrated in FIG. 11. Furthermore, the output control unit 113 can also perform control to output a measure necessary for executing the update process. For example, as illustrated in FIG. 12, the output control unit 113 may display a screen that indicates, by hatching, a location where the update process cannot be executed on the display device 3, and may also suggest movement to a location where the update process can be executed (location not hatched). At this time, the output control unit 113 may also display a message prompting movement to a location where the update process can be executed on the screen in FIG. 12. Furthermore, for example, the output control unit 113 may also perform control to superimpose and display the message in FIG. 11 on the screen in FIG. 12. Furthermore, for example, the output control unit 113 may also perform control to output, by audio from the speaker, a reason why the update process cannot be executed and a message prompting movement to a location where the update process can be executed, as illustrated in FIG. 13. This audio output may be performed simultaneously with the screen display in FIG. 11 or 12, or may be performed alone.

In the examples in FIGS. 11 to 13, the case where the vehicle 100 is located at the no entry area defined by the prohibition condition has been described as an example of the reason for not executing the update process. However, the present disclosure is not limited thereto. For example, when the vehicle 100 (gateway 10) stops in a state where the vehicle is not connected to the server device 6, it is also possible to output information that the vehicle is not connected to the network as a reason why the update process cannot be executed, and it is also possible to output information to urge connection to the network as a measure for executing the update process.

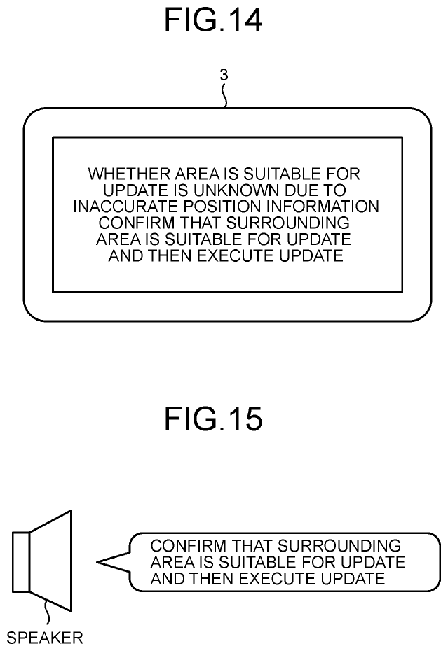

Furthermore, the output control unit 113 may also perform control to output information that the accuracy of the position information of the vehicle 100 is poor when the accuracy is poor. In the present embodiment, even when the vehicle 100 stops in a location where execution of the update process is determined to be permitted by the update determination unit 112, the accuracy of the position information of the vehicle 100 is determined before the above-described inquiry message is output. The output control unit 113 performs control to output information that the accuracy is poor when the accuracy is poor. For example, the output control unit 113 can control the display device 3 to display a message illustrated in FIG. 14. When the user reading this message determines himself/herself to execute the update process, the user can perform an operation of permitting execution of the update process by performing an operation on the operation unit 3a of the display device 3. Furthermore, for example, the output control unit 113 may also control the speaker to output an audio message illustrated in FIG. 15. On the other hand, when the accuracy of the position information is sufficient, the output control unit 113 performs control to output the above-described inquiry message.

As an example of a method of determining the accuracy of the position information, there may be a method of determining that the accuracy of the position information is poor when a period during which the GPS receiving device 8 cannot receive the GPS signal (in other words, a period during which the position information acquisition unit 201 cannot receive the GPS signal from the GPS receiving device 8) is a predetermined period or longer. In short, poor accuracy of the position information means a state in which the position information acquisition unit 201 cannot acquire the position information. A subject that determines the accuracy of the position information can be arbitrarily changed, and may be, for example, the output control unit 113 or another function.

Returning to FIG. 4, the description will be continued. The acceptance processing unit 114 illustrated in FIG. 4 performs a process of accepting the user's operation. More specifically, the display device 3 transmits the user's operation in the operation unit 3a to the gateway 10. The acceptance processing unit 114 can receive and accept the user's operation transmitted from the display device 3 via the in-vehicle communication unit 130.

When the update determination unit 122 determines that the update process can be executed, the update processing unit 115 causes the ECU 2 to execute the update process. In the present embodiment, when the acceptance processing unit 114 accepts an operation permitting execution of the update process by the user, the update processing unit 115 causes the ECU 2 to be updated (ECU 2 that can be updated using the update information already acquired from the server device 6) to execute the update process. The update processing unit 115 reads update information stored in the storage unit 120 acquired from the server device 6 and transmits the update information read to an update target ECU 2, and the update target ECU 2 executes the update process using the update information received. For example, the ECU 2 can update the program by overwriting the pre-update program stored in the storage unit 22 with a program included in the update information received from the update processing unit 115.

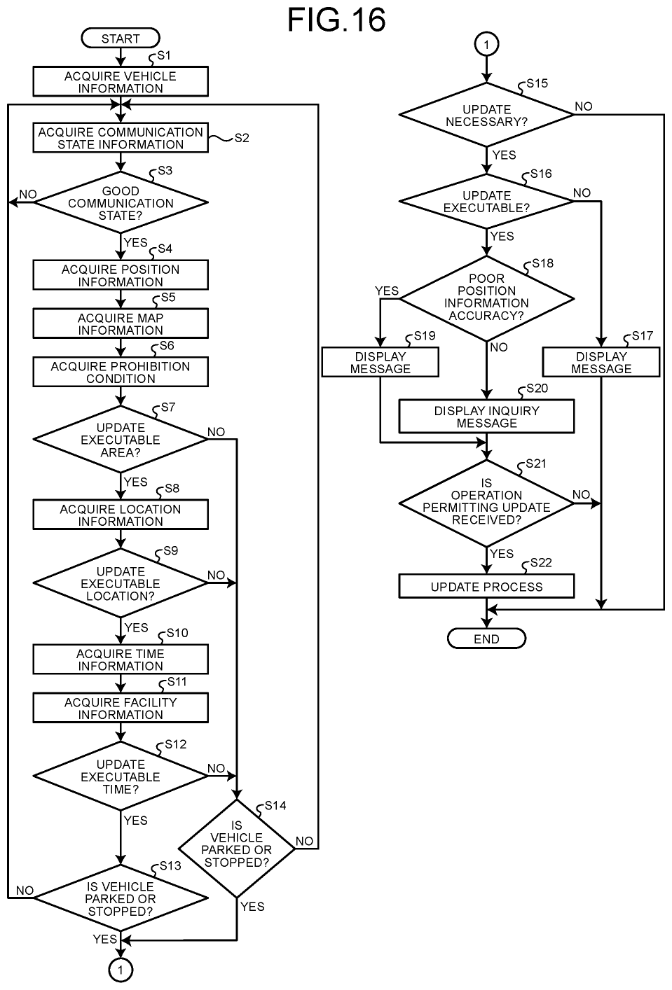

FIG. 16 is a flowchart illustrating an example of processes executed by the gateway 10 (processing unit 110) according to the present embodiment. The processing unit 110 repeatedly executes the processes illustrated in FIG. 16 in a predetermined cycle. Note that, in the following description of processes by each function included in the processing unit 110, description overlapping with the above description will be omitted as appropriate. Furthermore, the order of steps in the flowchart of FIG. 16 is not limited to the example in FIG. 16, and can be changed as appropriate.

As illustrated in FIG. 16, the vehicle information acquisition unit 204 acquires the vehicle information (Step S1). Next, the communication state information acquisition unit 208 acquires the communication state information (Step S2). When the update determination unit 112 determines that the communication state indicated by the communication state information acquired in Step S2 is good (Step S3: Yes), the process proceeds to Step S4. When the update determination unit 112 determines that the communication state is poor (Step S3: No), the process returns to Step S2.

In Step S4, the position information acquisition unit 201 acquires the position information of the vehicle 100 (Step S4). Next, the map information acquisition unit 202 acquires the map information (Step S5). Next, the prohibition condition acquisition unit 203 acquires the prohibition condition (Step S6).

Next, based on the vehicle information acquired in Step S1, the position information acquired in Step S4, the map information acquired in Step S5, and the prohibition condition acquired in Step S6, the update determination unit 112 determines whether the position of the vehicle 100 indicated by the position information is an area where the update process can be executed (Step S7). This determination method is as described above.

When a result in Step S7 is affirmative (Step S7: Yes), the location information acquisition unit 205 acquires the location information corresponding to the position information acquired in Step S4 (Step S8). When the result in Step S7 is negative (Step S7: No), the process proceeds to Step S14 described later.

After Step S8, the update determination unit 112 determines whether the position of the vehicle 100 is a location where the update process can be executed based on the location information acquired in Step S8 (Step S9). As described above, for example, when the degree of congestion indicated by the location information is equal to or greater than the threshold, the update determination unit 112 determines not to permit execution of the update process. In this case, it can be determined that the position of the vehicle 100 is not located in a place where the update process can be executed.

When a result in Step S9 is affirmative (Step S9: Yes), the time information acquisition unit 206 acquires the time information (Step S10), and the facility information acquisition unit 207 acquires the facility information related to the facility adjacent to the position indicated by the position information acquired in Step S4 (Step S11). When the result in Step S9 is negative (Step S9: No), the process proceeds to Step S14 described later.

After Step S11, the update determination unit 112 determines whether it is a time (timing) at which the update process can be executed based on the time information acquired in Step S10 and the facility information acquired in Step S11 (Step S12). As described above, for example, when the current time indicated by the time information is outside the business hours indicated by the facility information, the update determination unit 112 determines not to permit execution of the update process. In this case, it can be determined that it is not the time when the update process ca be executed. When a result in Step S12 is affirmative (Step S12: Yes), the process proceeds to Step S13, and when the result is negative (Step S12: No), the process proceeds to Step S14.

In Step S13, the update determination unit 112 determines whether the vehicle 100 is parked or stopped based on the IG signal. When the vehicle 100 is parked or stopped (Step S13: Yes), the update determination unit 112 determines that it is in a state where the update process can be executed, and the process proceeds to Step S15 described later. On the other hand, when the vehicle 100 is not parked or stopped (Step S13: No), the process returns to Step S2.

In Step S14, the update determination unit 112 determines whether the vehicle 100 is parked or stopped based on the IG signal. When the vehicle 100 is parked or stopped (Step S14: Yes), the update determination unit 112 determines that it is in a state where the update process cannot be executed, and the process proceeds to Step S15 described later. On the other hand, when the vehicle 100 is not parked or stopped (Step S14: No), the process returns to Step S2.

In Step S15, the update determination unit 112 determines whether the update process is necessary (Step S15). For example, when information for updating any ECU 2 is acquired from the server device 6, the update determination unit 112 can determine that the update process of the ECU 2 is necessary. When a result in Step S15 is negative (Step S15: No), the process ends. When the result in Step S15 is affirmative (Step S15: Yes), the update determination unit 112 checks whether it is in a state where the update process can be executed (Step S16).

When a result in Step S16 is negative (Step S16: No), i.e., when the vehicle 100 is parked or stopped in a state where the update process cannot be executed, the output control unit 113 controls the display device 3 to display a message indicating a reason why the update process cannot be executed as illustrated in FIG. 11 (Step S17), and the process ends. As described above, at this time, the output control unit 113 can also perform control to output (display output or audio output) a measure necessary for executing the update process.

When a result in Step S16 is affirmative (Step S16: Yes), i.e., when the vehicle 100 is parked or stopped in a state where the update process can be executed, the processing unit 110 determines whether the accuracy of the position information acquired in Step S4 is poor (Step S18). This determination method is as described above.

When a result in Step S18 is affirmative (Step S18: Yes), the output control unit 113 controls the display device 3 to display a message (e.g., FIG. 14) indicating poor communication state (Step S19). When a result in Step S18 is negative (Step S18: No), the output control unit 113 controls the display device 3 to display the above-described inquiry message inquiring of the user whether the update process can be executed (Step S20).

In Step S21 after Step S19 or Step S20, when the acceptance processing unit 114 receives the operation of permitting execution of the update process (Step S21: Yes), the update processing unit 115 causes the update target ECU 2 to execute the update process (Step S22).

As described above, the gateway 10 according to the present embodiment determines execution of the update process based on the position information, the map information, and the prohibition condition of the vehicle 100. As a result, since the location prohibiting execution of the update process can be dynamically changed according to the prohibition condition, it is possible to flexibly and appropriately determine whether the update process can be executed.

Further, the gateway 10 according to the present embodiment further determines whether the update process can be executed based on the vehicle information including at least the size or the type of the vehicle 100. In other words, it is determined whether the update process can be executed by dynamically changing the location prohibiting execution of the update process (location where execution of the update process is not permitted) by also reflecting the vehicle information, so that the determination can be made more flexibly and appropriately.

Furthermore, as described above, the gateway 10 according to the present embodiment determines whether the update process can be executed based on the location information corresponding to the position of the vehicle 100. For example, the location information includes information indicating the degree of congestion of other vehicles, and the gateway 10 according to the present embodiment described above determines not to permit execution of the update process when the degree of congestion indicated by the location information is equal to or greater than the threshold, so that it is possible to suppress worsening of congestion due to execution of the update process under a congested situation.

Furthermore, as described above, the gateway 10 according to the present embodiment determines whether the update process can be executed based on the time information. More specifically, when the current time indicated by the time information is outside the business hours of the facility adjacent to the location corresponding to the position of the vehicle 100, it is determined that execution of the update process is not permitted. As a result, for example, it is possible to suppress unnecessary parking for the update process in the parking lot adjacent to the facility outside the business hours of the facility.

Furthermore, as described above, the gateway 10 according to the present embodiment determines whether the update process can be executed, based on the communication state information, and determines not to permit execution of the update process when the communication state is poor (e.g., when the gateway 10 and the server device 6 are not connected to a network or when a sufficient communication speed cannot be secured). As a result, it is possible to suppress a problem that the update process is not completed for a long time due to, for example, a communication failure.

In addition, as described above, the gateway 10 according to the present embodiment performs control to output this information that the vehicle 100 stops in a location where the update determination unit 112 determines that the update process cannot be executed when the vehicle 100 stops in the location. As described above, when the vehicle 100 stops in a location where the update determination unit 112 determines that the update process cannot be executed, the gateway 10 according to the present embodiment controls the display device 3 to display a message indicating a reason why the update process cannot be executed. As a result, the user can immediately grasp the reason why the update process cannot be executed, and it becomes easy to take a measure necessary for executing the update process. Furthermore, the output control unit 113 can also perform control to output a measure necessary for executing the update process. Thus, the user can immediately grasp the measure necessary for executing the update process, and respond smoothly. As a result, user convenience can be improved.

Furthermore, as described above, the gateway 10 according to the present embodiment performs control to output information that the accuracy of the position information of the vehicle 100 is poor when the accuracy is poor. When the accuracy of the position information is poor, there is a possibility that the determination accuracy by the update determination unit 112 is also affected, and there is also a possibility that the update process is performed in a location where execution of the update process is not permitted. In this case, the present control intends to cause the user to determine whether the update process can be executed.

### Second Embodiment

Next, a second embodiment will be described. Description of parts common to those of the above-described first embodiment will be omitted as appropriate. The present embodiment is different from the first embodiment described above in that the gateway 10 performs control to output information indicating a location where the update process is determined to be executable or not, and performs control to output information that the vehicle 100 has entered the location where the update process can be executed or not when the vehicle 100 has entered the location. In the present embodiment, only a part of the function of the update determination unit 112 and the output control unit 113 is different from that of the above-described first embodiment, and other functions are similar to those of the above-described first embodiment.

In this example, it is assumed that a map for navigation based on map information is displayed on the display device 3 while the vehicle 100 is traveling. The update determination unit 112 determines a location where execution of the update process is not permitted in the map information based on the map information, the prohibition condition, the vehicle information, the location information, the time information, the facility information, and the communication state information described above. Hereinafter, in the map information, information indicating a location determined not permitting execution of the update process by the update determination unit 112 is referred to as update permission information.

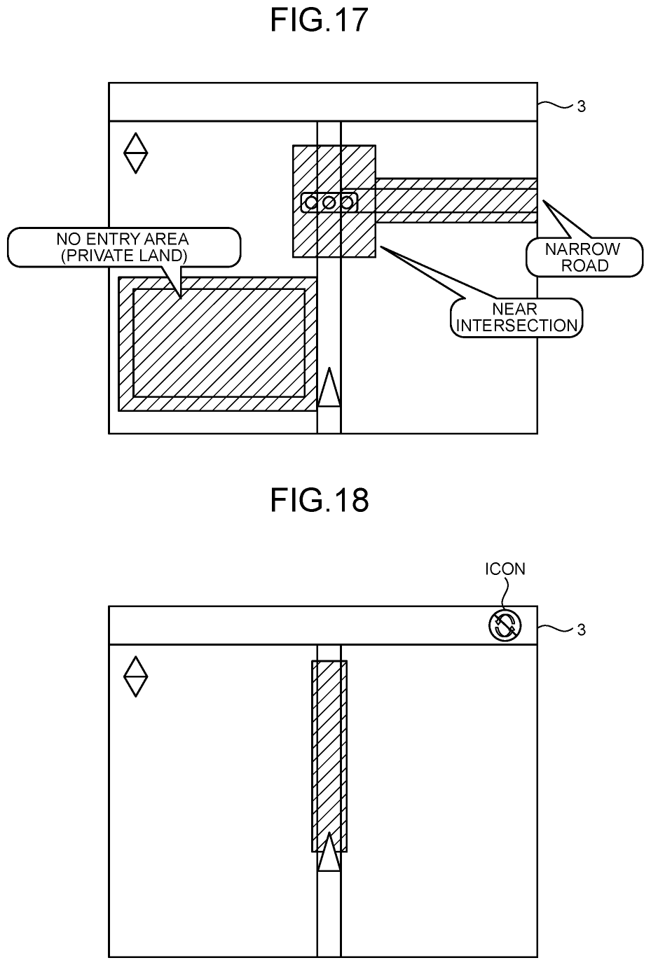

For example, the output control unit 113 can control the display device 3 to display the update permission information illustrated in FIG. 17. In the update permission information illustrated in FIG. 17, a location determined not to permit execution of update by the update determination unit 112 in the map information is indicated by hatching, but a display manner is arbitrary and is not limited thereto. For example, contrary to the above, hatching may be applied only to a location determined to permit the update process by the update determination unit 112 In short, the output control unit 113 may be in any mode as long as the output control unit 113 outputs information indicating a location determined to permit or not permit the update process by the update determination unit 112.

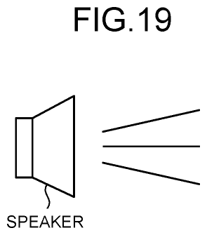

In addition, the output control unit 113 can perform control to output information that the vehicle 100 enters the location indicated by the above-described update permission information when the vehicle 100 enters the location. For example, as illustrated in FIG. 18, when the vehicle 100 enters a location in the map information where the execution of the update process is not permitted by the update determination unit 112, the output control unit 113 may display an icon indicating that execution of the update process is prohibited. Note that the output method for indicating that the vehicle 100 has entered the location indicated by the update permission information is not limited thereto and is arbitrary. For example, an icon of the vehicle 100 may be highlighted, or a message indicating that the vehicle 100 has entered the location indicated by the update permission information may be output by voice from a speaker as illustrated in FIG. 19.

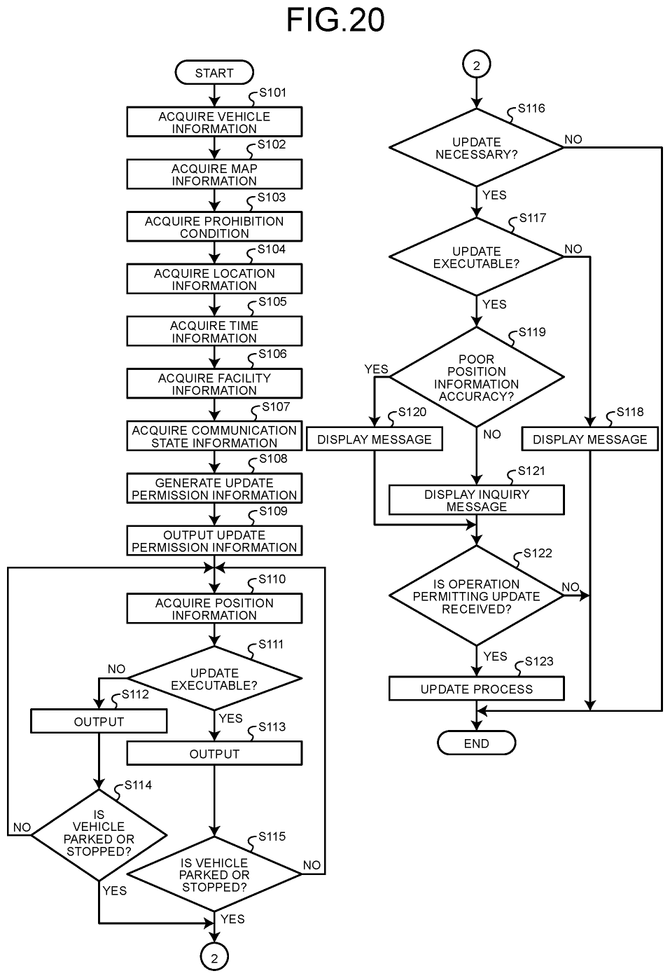

FIG. 20 is a flowchart illustrating an example of processes executed by the gateway 10 (processing unit 110) according to the second embodiment. Description of parts overlapping with those of the above-described first embodiment will be omitted as appropriate. Note that the order of steps in the flowchart of FIG. 20 is not limited to the example in FIG. 20, and can be changed as appropriate.

As illustrated in FIG. 20, the vehicle information acquisition unit 204 acquires the vehicle information (Step S101) . Next, the map information acquisition unit 202 acquires the map information (Step S102). Next, the prohibition condition acquisition unit 203 acquires the prohibition condition (Step S103). Next, the location information acquisition unit 205 acquires, for each location on the map information, location information indicating information on the location (Step S104). Next, the time information acquisition unit 206 acquires the time information (Step S105). Next, the facility information acquisition unit 207 acquires the facility information indicating information on each facility on the map information (Step S106). Next, the communication state information acquisition unit 208 acquires the communication state information (Step S107).

Next, the update determination unit 112 generates the above-described update permission information using the update determination information acquired in the above-described Steps S101 to S107 (Step S108). Next, the output control unit 113 performs control to output the update permission information generated in Step S108 (Step S109). In this example, the output control unit 113 controls the display device 3 to display the update permission information. As a result, the user who drives the vehicle 100 can grasp the location where the update process can be executed or the location where the update process cannot be executed by viewing the update permission information.

Next, the position information acquisition unit 201 acquires the position information of the vehicle 100 (Step S110). Next, the update determination unit 112 determines whether to permit execution of the update process based on the update permission information generated in Step S108 and the position information acquired in Step S110 (Step S111). In this example, the update determination unit 112 does not permit execution of the update process when the position information is included in a location where the update permission information indicates that execution of the update process is not permitted, and can permit execution of the update process when the position information is not included in the location where the execution of the update process is not permitted.

When a result in Step S111 is negative (Step S110: No), the output control unit 113 performs control to output information that the vehicle 100 has entered the location where execution of the update process is not permitted (Step S112). When the result in Step S111 is affirmative (Step S110: Yes), the output control unit 113 performs control to output information that the vehicle 100 has entered the location where execution of the update process is permitted (Step S113).

After Step S112, the update determination unit 112 determines whether the vehicle 100 is parked or stopped based on the IG signal (Step S114). When the vehicle 100 is parked or stopped (Step S114: Yes), the update determination unit 112 determines that it is in a state where the update process cannot be executed, and the process proceeds to Step S116. On the other hand, when the vehicle 100 is not parked or stopped (Step S114: No), the process returns to Step S110.

After Step S113, the update determination unit 112 determines whether the vehicle 100 is parked or stopped based on the IG signal (Step S115). When the vehicle 100 is parked or stopped (Step S115: Yes), the update determination unit 112 determines that it is in a state where the update process can be executed, and the process proceeds to Step S116. On the other hand, when the vehicle 100 is not parked or stopped (Step S115: No), the process returns to Step S110.

Since the processes in Step S116 and subsequent Steps are the same as the processes in Step S15 and subsequent Steps in FIG. 16 of the first embodiment, detailed description thereof is omitted.

As described above, the output control unit 113 according to the present embodiment performs control to output the update permission information indicating a location where the update determination unit 112 determines that the update process cannot be executed, and performs control to output information that the vehicle 100 enters the location indicated by the update permission information when the vehicle 100 enters the location. Thus, the user of the vehicle 100 can easily grasp whether the user is currently in the location where the update process cannot be executed. As a result, user convenience can be improved. In addition, a configuration of the present embodiment can also obtain similar effects as those of the first embodiment described above.

According to the present disclosure, it is possible to appropriately determine whether the update process can be executed. Note that effects described herein are not necessarily limited, and may be any of the effects described in the present specification.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory; and
a memory; and
a hardware processor coupled to the memory, the hardware processor being configured to:
determine whether an update process of updating a program or data for providing a function of an in-vehicle device mounted on the vehicle is executable, based on position information of a vehicle, map information, and a prohibition condition indicating a condition for prohibiting execution of the update process; and
cause the in-vehicle device to execute the update process when the determining that the update process is executable.

2. The information processing apparatus according to claim 1, wherein
the hardware processor is configured to determine whether the update process is executable, further based on vehicle information including at least a size or a type of the vehicle.

3. The information processing apparatus according to claim 1, wherein
the hardware processor is configured to determine whether the update process is executable, further based on location information indicating information regarding a location corresponding to the position information of the vehicle.

4. The information processing apparatus according to claim 3, wherein
the location information includes information indicating a degree of congestion of other vehicles, and
the hardware processor is configured not to permit execution of the update process when the degree of congestion indicated by the location information is equal to or greater than a threshold.

5. The information processing apparatus according to claim 1, wherein
the hardware processor is configured to determine whether the update process is executable, further based on time information.

6. The information processing apparatus according to claim 5, wherein
the hardware processor is configured not to permit execution of the update process when current time indicated by the time information is outside business hours of a facility adjacent to a location corresponding to the position information of the vehicle.

7. The information processing apparatus according to claim 1, wherein
the hardware processor is configured to determine whether the update process is executable, further based on communication state information indicating a communication state between the information processing apparatus and an outside.

8. The information processing apparatus according to claim 1, wherein
the hardware processor is further configured to perform control to output information indicating a location where the update process is determined to be executable or not, in the map information.

9. The information processing apparatus according to claim 1, wherein
the hardware processor is further configured to perform control to output information that the vehicle enters a location where the update process is determined to be executable or not, when the vehicle enters the location.

10. The information processing apparatus according to claim 1, wherein
the hardware processor is further configured to perform control to output information that the vehicle stops in a location where the update process is determined to be not executable, when the vehicle stops in the location.

11. The information processing apparatus according to claim 10, wherein
the hardware processor is configured to perform control to output a reason why the update process is not executable.

12. The information processing apparatus according to claim 10, wherein
the hardware processor is configured to perform control to output a measure necessary for execution of the update process.

13. The information processing apparatus according to claim 1, wherein
the hardware processor is further configured to perform control to output information that an accuracy of the position information is poor when the accuracy is poor.

14. An information processing method comprising:
determining whether an update process of updating a program or data for providing a function of an in-vehicle device mounted on a vehicle is executable, based on position information of the vehicle, map information, and a prohibition condition indicating a condition for prohibiting execution of the update process; and
causing the in-vehicle device to execute the update process when it is determined that the update process is executable in the determining.

15. A non-transitory computer readable medium on which programmed instructions are stored, wherein the programmed instructions, when executed by a computer, cause the computer to perform:
determining whether an update process of updating a program or data for providing a function of an in-vehicle device mounted on a vehicle is executable, based on position information of the vehicle, map information, and a prohibition condition indicating a condition for prohibiting execution of the update process; and
causing the in-vehicle device to execute the update process when it is determined that the update process is executable in the determining.
